(19) United States
(12) Patent Application Publication
(10) Pub. No.: US 2022/0037869 A1
(43) Pub. Date: Feb. 3, 2022

(54) SECURING STRIP

(71) Applicant: AUDI AG, Ingolstadt (DE)

(72) Inventor: Mario KNOBLOCH, Zeitz (DE)

(73) Assignee: AUDI AG, Ingolstadt (DE)

(21) Appl. No.: 17/278,464

(22) PCT Filed: Aug. 30, 2019
(86) PCT No.: PCT/EP2019/073158

§ 371 Date: Mar. 22, 2021

(30) Foreign Application Priority Data
Sep. 25, 2018 (DE) 10 2018 216 274.3

(51) Int. Cl. H02G 3/32

(52) U.S. Cl. CPC H02G 3/32

(57) ABSTRACT

A fastening strip for an oblong component, which includes multiple carrier segments for accommodating the components. The carrier segments are arranged in succession and each two directly adjacent carrier segments are respectively connected to one another via a film hinge.

A cable conduit can be used to accommodate a cable. However, such a cable conduit is formed as a rigid body.

Document U.S. Pat. No. 9,809,179 B2 describes a device for guiding an electrical wire.

An arrangement for housing a cable is known from document U.S. Pat. No. 9,972,984 B1.

Against this background, it was an object to provide a deformable fastening for a cable.

This object is achieved by a fastening strip and methods having the features of the independent claims Embodiments of the fastening strip and the methods are disclosed in the dependent claims

The fastening strip according to the invention is designed or provided for an oblong component and includes multiple, for example fixed, solid, and/or rigid carrier segments for accommodating the component, which are arranged in succession in a series, for example. Each two directly adjacent carrier segments are respectively connected to one another via a, for example flexibly and/or elastically deformable film hinge.

Since the carrier segments are connected to one another via flexibly and/or elastically deformable film hinges, the fastening strip or a corresponding retaining strip is also flexibly and/or elastically deformable. It is possible that the fastening strip can be arranged at and/or on differently shaped parts, wherein the fastening strip can be adapted accordingly to a shape or contour of a respective part. The fastening strip can be used, for example for a vehicle, in particular a motor vehicle or automobile. Parts or component parts on which oblong components are to be fastened typically have shapes and/or surfaces which deviate from linear and/or flat shapes. Using the fastening strip, an oblong component can now also be fastened at or on a nonlinear and/or uneven component. The fastening strip comprises a chain of multiple carrier segments connected to one another via film hinges, which can be moved relative to one another, wherein the fastening strip adapts itself to a contour of a respective part.

For this purpose, each carrier segment or supporting segment includes a receptacle element, for example a clip, a clamping element, or a bracket, for accommodating in each case a section of the oblong component or an oblong line element. Overall, the component is accommodated by multiple receptacle elements along the series of carrier segments connected to one another, wherein it is possible that in each case one section of the component is clipped and/or clamped in a receptacle element and thus accommodated therein. Every carrier segment of the fastening strip is movable relative to every other carrier segment.

The fastening strip is designed in one embodiment for accommodating an oblong electrical component or line element designed, for example as a cable, line, or hose. The component that can be accommodated or is to be accommodated using the fastening strip typically has a cross-sectional area which can be formed circular or polygonal, wherein the component can extend along a, for example central longitudinal axis perpendicular to the cross-sectional area. The component to be accommodated can also be elastically deformable in this case.

The first method according to the invention is provided for producing a fastening strip or retaining strip for an oblong component. The fastening strip to be produced using the first method includes multiple carrier segments for accommodating the component, which are arranged in succession in a series, wherein each two directly adjacent carrier segments are respectively connected to one another via a film hinge.

It is possible that to produce at least a part or section of the fastening strip, the carrier segments and the film hinges of the fastening strip are produced completely from a coherent body using an injection molding tool. It is possible to produce the fastening strip as quasi-infinite piece goods and to sever, for example to cut off a section thereof or a chain of carrier segments connected to one another having a required length.

Furthermore, it is alternatively or additionally possible that a film hinge is injected onto each two carrier segments to be arranged directly adjacent to produce the at least one part or section of the fastening strip. A film hinge is arranged here between each two carrier segments. It is thus possible, for example, to connect two sections or chains from two original fastening strips to one another and thus to form a longer fastening strip, wherein each two carrier segments at one end of a respective original fastening strip are connected via a film hinge which is arranged, for example fastened, on these two carrier segments. The fastening strip can be designed variably with respect to its length or adjusted in length as required, for example lengthened or shortened.

The second method according to the invention is provided for fastening an oblong component at and/or on a surface of a part. An embodiment of the fastening strip according to the invention is used here, which is produced by an embodiment of the first method according to the invention for producing the fastening strip.

In this case, one section of the oblong element is accommodated in each case by a carrier segment or supporting segment, wherein it is possible that each segment is clipped and/or clamped into a receptacle element of the respective carrier segment. A receptacle element can include a groove in each case, which is delimited by two groove walls, for example two legs or arms. Alternatively or additionally, it is possible to thread the oblong component into receptacle elements of multiple carrier segments arranged in succession along the fastening strip. In this case, a receptacle element can also enclose a groove for accommodating a section of the oblong component. Alternatively, it is conceivable that a receptacle element encloses a tunnel-shaped opening into which the component is threaded, i.e., that the receptacle element is formed as a type of eye.

In addition, it is possible that at least some of the carrier segments or supporting segments, in general each carrier segment, is or are fastened on the surface of the part. The carrier segments can be fixedly adhesively bonded via at least one adhesive element on the surface. It is possible here that an adhesive surface of the at least one adhesive element is arranged in each case on one side of a carrier segment which is to be fastened on the surface, whereas the receptacle element for accommodating the component is arranged on the side of the respective carrier segment facing away therefrom. Since the carrier segments are movable relative to one another, the fastening strip can adapt itself to a contour and thus a shape of the part.

A flexible fastening strip which is adaptable, for example with respect to its shape, for an electronic line and other electronic components is provided with an embodiment of the first method.

One possible application of the fastening strip and the methods suggests itself in automotive engineering. Thus, for example, in some premium motor vehicles, sensor-controlled rear hatches are installed which offer a customer additional comfort when opening a rear hatch. Such opening is triggered by an air kick below a rear bumper and/or a rear apron. To be able to detect this air kick, for example two coaxial lines are installed in a panel of the bumper. In each case one coaxial line is fastened via special holding devices in a diffuser or in the panel.

Since a very high level of variation can occur here in the installation, this is linked to high investment, development, and testing costs.

In contrast, the fastening strip presented here can be adapted to an arbitrarily shaped part, for example a component of a motor vehicle, and fastened thereon. Tool and development costs can thus be saved. A lower individual part price results due to piece count effects in the production of the fastening strip.

There is the possibility that the complete fastening strip is produced from or using a single injection molding tool. The individual carrier segments are connected to one another here via off-tool film hinges, i.e., the film hinges are easily demoldable from an injection mold of the injection molding tool and can be removed. In this case, it is not necessary to connect the carrier segments to one another or assemble them subsequently. Independently of how an individual section of the fastening strip is produced, the oblong component can be inserted into the receptacle elements of the carrier segments, clipped with the receptacle elements, and/or clamped in the receptacle elements.

It is obvious that the above-mentioned features and the features still to be explained hereinafter are usable not only in the respective specified combination but also in other combinations or alone without leaving the scope of the present invention.

The invention is schematically illustrated on the basis of an embodiment in the drawings and is described schematically and in detail with reference to the drawings.

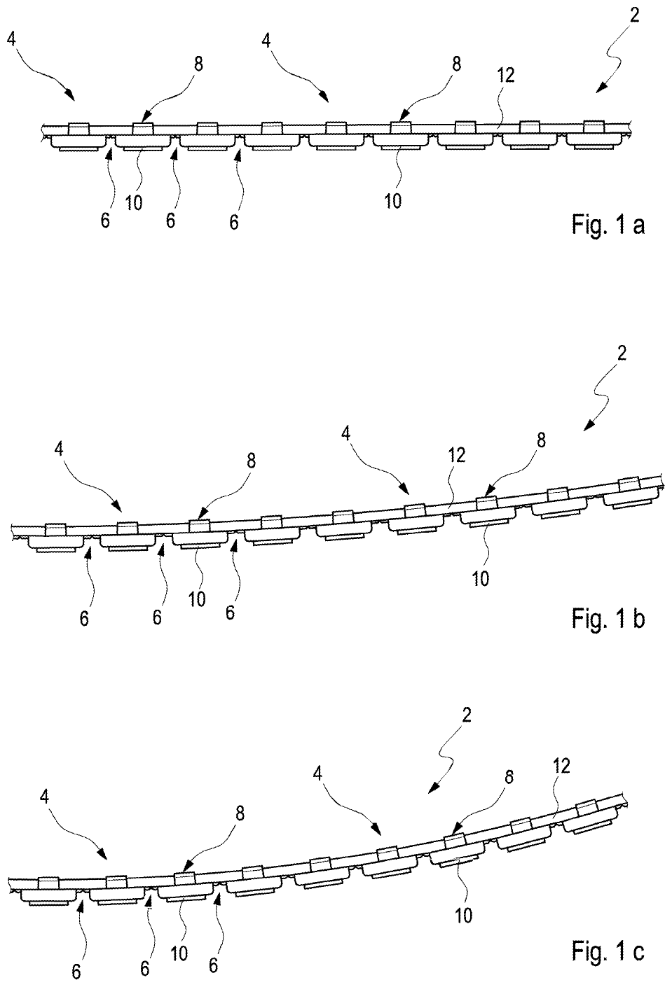

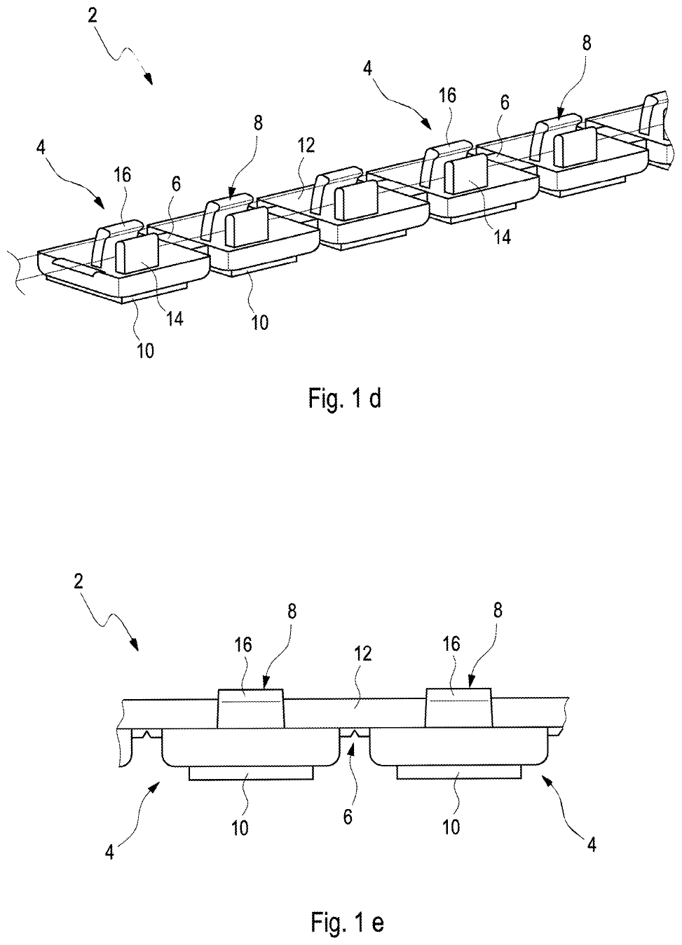

FIG. 1 shows a schematic illustration of an embodiment of the fastening strip according to the invention.

The figures are described coherently and comprehensively, identical reference signs are assigned to the same components.

FIGS. 1a, 1b, and 1c show in schematic illustrations the embodiment of the fastening strip 2 according to the invention, which can also be denoted and/or formed as a holding strip, in different states, in which it is bent or curved by different amounts. FIGS. 1d to 1e show enlarged details of the fastening strip 2.

The fastening strip 2 comprises a plurality of carrier segments 4, wherein each two directly adjacent carrier segments 4 are respectively connected to one another via a flexibly and/or elastically deformable film hinge 6. Each carrier segment 4 has a receptacle element 8 on an upper side and an adhesive element 10 on a lower side facing away therefrom.

Each receptacle element 8 comprises two groove walls 14, 16 arranged adjacent to one another here, between which a groove is located, wherein the two groove walls 14, 16 delimit the groove. A section of a cable 12 is accommodated here as an oblong component and/or line element within the groove of each receptacle element 8, for example clipped and/or clamped therein. A cross-sectional area of the groove is at least as large as a cross-sectional area of the cable 12 as the oblong component. An opening of the groove is arranged between the ends of the two groove walls 14, 16, but has a width which is less than a diameter of the cable 12. In one embodiment, at least one groove wall 14, 16 or a corresponding leg of the receptacle element 8 is elastically deformable, wherein the groove walls 14, 16 can be spread relative to one another when the section of the cable 12 is arranged therein. Furthermore, the section of the cable 12 is captively accommodated in each case in a groove of a receptacle element 8. Overall, the cable 12 is accommodated here in multiple grooves of multiple receptacle elements 8 along the fastening strip 2.

The two groove walls 14, 16 of the receptacle element 8 are designed or formed differently here. A first groove wall 14 has a linear profile, while in contrast a second groove wall 16 has a curved profile and is longer or taller than the first groove wall 14. The first groove wall 14 encloses the groove and the cable 12 arranged therein with a flat or linear surface. The second groove wall 16 encloses the groove and the cable 12 arranged therein with a bent or curved surface, wherein the first groove wall 14 and the second groove wall 16 are oriented in relation to one another at an acute angle. If the cable 12, which is cylindrical in cross section, is arranged in the groove between the two groove walls 14, 16, the bent surface of the second groove wall 16 presses against an outer surface of the cable 12 and encloses it in an angle range of at most 90°. In this case, the flat surface of the first groove wall 14 presses against the cable 12 along a line.

Due to the elastic deformability of the film hinges 6, it is possible to arrange the fastening strip 2 having the cable 12 accommodated therein linearly (FIG. 1a) are curved or bent by different amounts (FIGS. 1b and 1c). The individual carrier segments 4 can be tilted in relation to one another via the film hinges 6 and thus adapt themselves to differently curved or arched surfaces. Furthermore, it is provided that the fastening strip 2 having the accommodated cable 12 is fastened on a surface of a part (not shown in greater detail here), wherein the fastening strip 2 adapts itself to a section and thus to a geometry or a design and/or surface contour of the part.

In one embodiment, the fastening strip 2 is fastened on a part of a motor vehicle, for example to a vehicle body part, a bumper, a diffuser, or a hatch, in particular a rear hatch, or a door for an opening of the motor vehicle, wherein it is possible to adapt the fastening strip 2 to a respective contour and/or geometry of an area, in particular a surface, of the part. The fastening strip 2 can thus be fastened on differently shaped parts from different product series.

The carrier segments 4 are formed or produced here from plastic, for example from polypropylene (PP) or ethylene-propylene-diene rubber (EPDM), in particular “PP EPDM T20”. The film hinges 6 are injected here onto the carrier segments 4. Alternatively, all components of the fastening strip 2, i.e., the carrier segments 4 and film hinges 6, can be produced as a coherent body. Furthermore, it is possible to variably adapt a length of the fastening strip 2. If, for example, an actual length of the fastening strip 2 is longer than an intended length, it is possible to shorten the fastening strip 2 by severing a section of the fastening strip 2. In contrast, for example, if an actual length of the fastening strip 2 is shorter than an intended length, it is possible to lengthen the fastening strip 2 by adding a section of a further fastening strip 2. Ends of the two fastening strips 2, on each of which a carrier segment 4 is located, can be connected to one another via a film hinge 6, which is fastened on both carrier segments 4.

The carrier segments 4 and thus the fastening strip 2 is or are fastened on a base surface of the component, for example via an adhesive pad or double-sided adhesive tape as the adhesive element 10. The cable 12 or a line, which can also be formed as an antenna, is then fastened on the molded-on receptacle elements 8, for example clips, of the carrier segments 4. Individual carrier segments 4 at the end of the fastening strip 2 can be broken off at the film hinges 6, if they are not needed or they interfere.

### LIST OF REFERENCE NUMERALS

2 fastening strip

4 carrier segment

6 film hinge

8 receptacle element

10 adhesive element

12 cable

14 first groove wall

16 second groove wall

1-10. (canceled)

11. A fastening strip for an oblong component, which includes multiple carrier segments for accommodating the components, wherein the carrier segments are arranged in succession and each two directly adjacent carrier segments are respectively connected to one another via a film hinge.

12. The fastening strip as claimed in claim 11, in which each carrier segment includes a receptacle element for accommodating one section of the oblong component in each case.

13. The fastening strip as claimed in claim 11, which is designed to accommodate an oblong component designed as a cable and/or line.

14. A method for producing a fastening strip for an oblong component, which includes multiple carrier segments for accommodating the component, wherein the carrier segments are arranged in succession and each two directly adjacent carrier segments are respectively connected to one another via a film hinge.

15. The method as claimed in claim 14, in which the carrier segments and the film hinges of the fastening strip are produced using an injection molding tool from one body.

16. The method as claimed in claim 14, in which a film hinge is injected onto each two carrier segments to be arranged directly adjacent.

17. The method as claimed in claim 14, in which the fastening strip is lengthened or shortened.

18. The fastening strip as claimed in claim 12, which is designed to accommodate an oblong component designed as a cable and/or line.

19. The method as claimed in claim 15, in which a film hinge is injected onto each two carrier segments to be arranged directly adjacent.

20. The method as claimed in claim 15, in which the fastening strip is lengthened or shortened.

21. The method as claimed in claim 16, in which the fastening strip is lengthened or shortened.
